(19) United States
(12) Patent Application Publication
(10) Pub. No.: US 2024/0311769 A1
(43) Pub. Date: Sep. 19, 2024

(54) SYSTEM FOR PROVIDING TAILOR-MADE AND CUSTOMIZABLE JOBS AND SERVICES PLATFORM

(71) Applicant: Reza Taleb, Irvine, CA (US)

(72) Inventor: Reza Taleb, Irvine, CA (US)

(21) Appl. No.: 18/578,521

(22) PCT Filed: Jul. 14, 2022
(86) PCT No.: PCT/US2022/037134

§ 371 Date: Jan. 11, 2024

Related U.S. Application Data
(60) Provisional application No. 63/221,493, filed on Jul. 14, 2021.

(51) Int. Cl. G06Q 10/1053; G06Q 10/0631

(52) U.S. Cl. CPC G06Q 10/1053; G06Q 10/063112

(57) ABSTRACT

A computer-implemented system for providing customizable jobs and services platform is disclosed. The system is configured to simulate an employment process by creating a unique platform with maximum possibilities for short-term employment. The unique platform allows employers and employees to come together to perform or ask for any services/tasks/expertise without a middle-man, thereby connecting people from different backgrounds and industries to come together under a single platform and help each other in diverse expertise. The unique platform allows employers to hire employees in another country remotely for virtual and physical tasks without a middle-man in real time, within a few hours on a short-term basis or on a long-term basis.

### CROSS-REFERENCE TO RELATED APPLICATIONS

This application claims priority to PCT Patent Application No. PCT/US2022/037134 title “Tailor-Made and Customizable Jobs and Services Platform” filed on 14 Jul. 2022 which further claims the benefit of US provisional application U.S. 63/221,493 filed on 14 Jul. 2021 entitled “Tailor-made and Customizable Jobs and Services Platform”, the contents of which are hereby incorporated by reference.

### FIELD OF INVENTION

The present invention relates generally to online jobs and service platforms, and in particular, to a system for providing customizable jobs and services platform that opens up possibilities for individuals and companies to employ and get employed on their own schedule with the most competitive prices without the intervention of a middle-man.

### BACKGROUND OF THE INVENTION

As societies are becoming more modern and technically advanced, there exists a need for a universal service-oriented company that holds a wide variety of services, Gig workers, and employers under a single platform in a flexible manner. The platform becomes more and more evident, which can provide opportunities to members of societies to gain extra income in exchange for the services they provide or save money on services.

Currently, the existing Gig Economy platforms are mostly focused on either one main service or a very narrowed-down couple of services. There is no universal and verifiable career-oriented platform where anyone can offer their services, talents, or their extra time to others and earn additional income. Unemployment is high in many societies, while the need for diverse services is there. There is no effective platform that has short-/long-term jobs/tasks with more flexibility to both employer and employee. Further, there is no effective system that has diverse services under one platform and can bring the employer and employees together and connect the demand to supply effectively. In addition, there is no single platform to employ someone for a small customized task on a flexible schedule with minimal long-term commitment for both an employer and an employee to work as a freelancer with a short process of employment in a competitive manner.

Many gig economy platforms merely concentrate on virtual jobs while the obvious need for diverse physical jobs is still unmet. When service providers change their location, for example, City or Country, they usually have very few contacts and references and have to start from ground Zero. There is no system that keeps track of people's careers and reviews from former employers in an archived verifiable form. There is no fair system that enables users to multitask and be able to advertise their diverse expertise, talents, and services. Also, there is no system that is able to employ others freely without a middleman or get employed by others freely. There is also no unified system that enables users to view any reviews or feedback on how others perform in their jobs and how effective they are from the standpoint of the people they serve.

The process of employment even for the companies is fundamentally unchanged for decades while the needs of the societies are changed drastically at the same time. Employers still have to go through a complex HR filtering system that is costly and time-consuming and base their initial judgment on a couple of pages of the applicant's resume without any track records of the applicant's true level of skills and how qualified they are. Also, currently, there are no universal platforms that can freely give someone access to be able to employ an employee in another part of the world or get employed by someone from another part of the world on an interactive live map to get any tailor-made or customized jobs or demands done.

Therefore, there is a need for a system for providing a tailor-made and customizable jobs and services platform. Also, there is a need for a system for providing possibilities for individuals and companies to employ and get employed on their own schedule with the most competitive prices without the intervention of a middle-man.

There is no system that provides a service of hiring a worker in another country to perform not a virtual but a real task in real time or over a short period, for example, within 3 hours.

### SUMMARY OF THE INVENTION

The present invention generally discloses an online jobs and service platform. Further, the present invention discloses a system for providing a customizable jobs and service platform that opens up possibilities for individuals and companies to employ and get employed on their own schedule with the most competitive prices without the intervention of a middle-man.

In one embodiment, the system is a computer-implemented system executed in a network environment for providing a customizable jobs and services platform. The system is an innovative and intelligent online solution that has been designed to bring users, such as employers and employees under a single platform to perform or ask for any services/tasks/expertise without the intervention of a middle-man. In one embodiment, the system provides a unique online platform for users (employers and employees) to recruit each other for any routine/customized/tailor-made jobs. In one embodiment, the system runs in a computer-implemented network environment or network environment to provide a unique platform (i.e., Djobzy) for employees or candidates to look for jobs and employers or technology service providers to look for talented candidates or employees.

In one embodiment, the network environment comprises one or more user devices. The user device has an interactive user interface. Each user device is associated with a user. In one embodiment, the user may be, but not limited to, candidates or employees or any other resource looking for jobs and employers or service providers or organizations. In one embodiment, the user device is installed with a digital platform (i.e., Djobzy). In one embodiment, the digital platform may be an application software or mobile application or web-based application or software application, or desktop application. In one embodiment, the platform is a web-based/mobile-app-based, Gig economy/Shared economy platform that enables any two parties to be able to recruit each other for any routine/customized/tailor-made jobs, errands, and tasks for a certain amount of time for any task/jobs. The job may be from highly professional employers that need specific expertise to any daily errand/tasks/jobs in any part of the world to perform any legal tasks that can save individuals, corporations, entities even government and authorities lots of time and money. In one embodiment, the platform mainly focused on short-term customized job service that enables employers to save time, and money in finding the right people to get the tasks done, and at the same time to find jobs for employees to perform and make extra income.

In one embodiment, the system further comprises a communication network and a resource management system. In one embodiment, the user device is enabled to access the resource management system via the network. In one embodiment, the user device enables the user to access one or more services provided by the system. In one embodiment, the user device is at least any one of a smartphone, a mobile phone, a tablet, a laptop, a desktop, and/or other suitable hand-held electronic communication devices. In one embodiment, the user device comprises a storage medium in communication with the network to access the resource management system. In an embodiment, the network could be Wi-Fi, WiMAX, wireless local area network (WLAN), satellite networks, cellular networks, private networks, and the like.

In one embodiment, the resource management system comprises a computing device and one or more databases in communication with the computing device. In one embodiment, the computing device is a server. In one embodiment, the computing device could be a cloud server. In one embodiment, the server could be operated as a single computer. In some embodiments, the computer could be a touchscreen and/or non-touchscreen and adapted to run on any type of OS, such as iOS™, Windows™, Android™, Unix™, Linux™, and/or others. In one embodiment, the plurality of computers is in communication with each other, via networks. Such communication is established via any one of the application software, a mobile application, a browser, an OS, and/or any combination thereof.

In one embodiment, the one or more databases are in communication with the computing device via the network. In one embodiment, the databases are accessible by the computing device. In another embodiment, the databases are integrated into the computing device or separate from it. In some embodiments, the databases reside in a connected server or a cloud computing service. Regardless of location, the databases comprise a memory to store and organize certain data for use by the computing device. In one embodiment, the database is configured to store a plurality of users' profile information.

In one embodiment, the computing device comprises at least one processor and a non-transitory memory unit or computer-readable medium or memory unit coupled to the processor. The memory unit stores a set of instructions executable by the processor configured to provide customizable jobs and services, thereby allowing employers to recruit suitable candidate profiles based on assigned task and candidate expertise as well as employees to look for suitable jobs offered by the employer. In one embodiment, the memory unit could be RAM, ROM (including EPROM, EEPROM, PROM).

In one embodiment, the computing device is configured to simulate an employment process by creating a unique platform with maximum possibilities for short-term employment. In one embodiment, the unique platform allows employers and employees to come together to perform or ask for any services/tasks/expertise without a middle man, thereby connecting people from different backgrounds and industries to come together under a single platform and help each other in diverse expertise.

In one embodiment, the platform creates a space in the online world to enable everyone to provide services and to get services from other members of the society. For example, when a person enters a cafe, a waitress is employed for a couple of seconds to prepare and give the order and the person becomes a temporary employer at that moment usually without realizing it. This situation happens on a daily basis. Similarly, to use mobile and computer, the mobile network companies are employed to give internet access for the employment process. Mostly short-term employment is happening constantly in lives without realizing it in many cases. In an exemplary embodiment, the unique platform is trying to simulate the same processes with the use of technology to maximize the possibilities. The platform brings employers and employees together under a single platform to perform or ask for any services/tasks/expertise without a middle-man would eventually result in faster communication, saving cost, and creating opportunities for others who are looking to work extra hours, earn money instantly and gain additional income. In one embodiment, the unique platform ultimately connects people from different backgrounds and industries to come together and help each other in diverse walks of life. This would increase profitability and stimulate a sense of usefulness amongst people with different expertise. In one embodiment, the platform aims to provide a valid background of users' working history, their reviews, and quality of their service and expertise.

In one embodiment, the system locates employees, service seekers, and employers on an interactive live map. In one embodiment, the system further comprises a plurality of categories for jobs and employers on the interactive map with the location of job sites and the employees. In one embodiment, the employer creates a job post with title and description, categories, requirements, language and job location or creates a remote job not related to a specific location, attachments, contract duration, and budget. In one embodiment, the employee creates a Promoted Service by choosing one or more categories and creating unique services by adding price and description.

In one embodiment, the system further comprises multi-level verification system configured to raise a user's verification level to the level that user wants or sees fit and by each increment and approval of that verification level by the platform the user can reach higher number of applicants and interest on its corresponding profile, the invention of multilevel verification system keeps the flexibility for the user to verify the level of their liking while providing possibility for increasing the KYC and therefore safety measures meanwhile rewarding users to be able to easily upgrade to higher verification level and attract more interest and a higher level of mutual trust between users, and chance of landing a good job or finding an employee. In one embodiment, the system further comprises a search system configured to provide a possibility to search by categories as well as employees or jobs. In one embodiment, the system further comprises a wallet and payment system configured to track pending and completed transactions, balance, and to view all funds that are ready to be released once both the employer and employee have deemed the job completed. In one embodiment, the system further comprises an escrow account configured to protect both employers and employees from malicious acts, takes blind trust out of the equation, and guarantees satisfaction for both sides before the transaction is completed.

In one embodiment, the system allows the users to hire an employee for any hybrid job that requires diverse expertise, choose diverse industries, and find a personal assistant. In one embodiment, the system further allows the employee to advertise their services on the unique platform that is noticeable by many employers requiring such services. In one embodiment, the system is configured to shop for services for the best price, create a web shop of services in a couple of minutes, and sell the services to get paid instantly. In one embodiment, the system enables users to come together and perform activities of diverse sorts, whether hiking, any sports, social gatherings, mentoring, hangouts, assistance, delivery, cooking, babysitting, consulting and other activities.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The invention may be better understood from the following non-limiting description of preferred embodiments, in which:

FIG. 1 shows a computer-implemented system executed in a network environment in an embodiment of the present invention;

FIG. 2 shows a screenshot of an employee's dashboard in one embodiment of the present invention;

FIG. 3 shows a screenshot of an employee's profile in one embodiment of the present invention;

FIG. 4 shows a screenshot of an employer's dashboard in one embodiment of the present invention;

FIG. 5 shows a screenshot of an employer's profile in one embodiment of the present invention;

FIG. 6 shows a screenshot to create a job post in one embodiment of the present invention;

FIG. 7 shows a screenshot to make a Promoted Service in one embodiment of the present invention;

FIGS. 8A-8E show screenshots of verification steps to raise a user's verification level in one embodiment of the present invention;

FIG. 9 shows a screenshot of a search system in one embodiment of the present invention;

FIG. 10 shows a screenshot of a category browser in one embodiment of the present invention;

FIG. 11 shows a screenshot of a job post in one embodiment of the present invention;

FIG. 12 shows a screenshot that demonstrates how to apply for the job in one embodiment of the present invention;

FIG. 13 shows a screenshot of bidding profiles in one embodiment of the present invention;

FIG. 14 shows a screenshot of a job offer sent by an employer in one embodiment of the present invention;

FIGS. 15A-15B show screenshots of a wallet and payment system in one embodiment of the present invention;

FIG. 16 shows a screenshot of payment methods in one embodiment of the present invention;

FIG. 17 shows a screenshot of a referral system in one embodiment of the present invention;

### DETAILED DESCRIPTION OF THE DRAWINGS

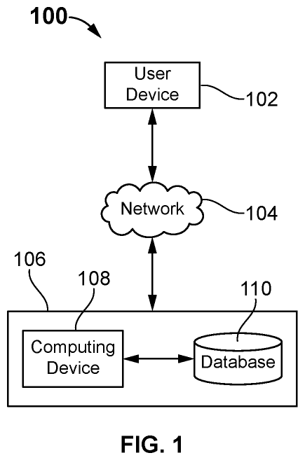

Referring to FIG. 1, a computer-implemented system executed in a network environment 100 for providing customizable jobs and services platform, according to one embodiment of the present invention. The system is an innovative and intelligent online solution that has been designed to bring users such as employers and employees under a single platform to perform or ask for any services/tasks/expertise without the intervention of a middle-man. In one embodiment, the system provides a unique online platform for users (employers and employees) to recruit each other for any routine/customized/tailor-made jobs. In one embodiment, the system runs in a computer-implemented network environment or network environment 100 to provide the unique platform (i.e., Djobzy) for employees or candidates to look for jobs and employers or technology service providers to look for talented candidates or employees.

The term “Djobzy” is defined as a gig-economy multi-streaming job search/recruitment platform that connects everyday people through short-term customized job placements either by offering their services to others or looking for any services. On the platform people can create a task out of anything in their mind to find individuals around them to do it. Anyone with any talent, expertise or extra time willing to perform any legal services in their jurisdiction can apply to find employment or give jobs to other people.

In one embodiment, the network environment 100 comprises one or more user devices 102. The user device 102 has an interactive user interface. Each user device 102 is associated with a user. In one embodiment, the user may be, but not limited to, candidates or employees or any other resource looking for jobs and employers or service providers or organizations. In one embodiment, the user device 102 is installed with a digital platform (i.e., Djobzy). In one embodiment, the digital platform may be an application software or mobile application or web-based application or software application, or desktop application. In one embodiment, the platform is a web-based/mobile-app-based, Gig economy/Shared economy platform that enables any two parties to be able to recruit each other for any routine/customized/tailor-made jobs, errands, and tasks for a certain amount of time. The job may be from highly professional tasks that need specific expertise to any daily errands/tasks/jobs in any place of the world that can save individuals, corporate, entities, even government and authorities lots of time and money. In one embodiment, the platform mainly focused on short-term customized job service that enables employers to save time, and money in finding the right people to get the tasks done, and at the same time to find jobs for employees to perform and make extra income.

In one embodiment, the system further comprises a communication network 104 and a resource management system 106. In one embodiment, the user device 102 is enabled to access the resource management system 106 via the network 104. In one embodiment, the user device 102 enables the user to access one or more services provided by the system. In one embodiment, the user device 102 is at least any one of a smartphone, a mobile phone, a tablet, a laptop, a desktop, and/or other suitable hand-held electronic communication devices. In one embodiment, the user device 102 comprises a storage medium in communication with the network 104 to access the resource management system 106. In an embodiment, the network 104 could be Wi-Fi, WiMAX, wireless local area network (WLAN), satellite networks, cellular networks, private networks, and the like.

In one embodiment, the resource management system 106 comprises a computing device 108 and one or more databases 110 in communication with the computing device 108. In one embodiment, the computing device 108 is a server. In one embodiment, the computing device 108 could be a cloud server. In one embodiment, the server could be operated as a single computer. In some embodiments, the computer could be a touchscreen and/or non-touchscreen and adapted to run on any type of OS, such as iOS™, Windows™, Android™, Unix™, Linux™, and/or others. In one embodiment, the plurality of computers is in communication with each other, via networks. Such communication is established via any one of application software, a mobile application, a browser, an OS, and/or any combination thereof.

In one embodiment, the one or more databases 110 are in communication with the computing device 108 via the network 104. In one embodiment, the databases 110 are accessible by the computing device 108. In another embodiment, the databases 110 are integrated into the computing device 108 or separate from it. In some embodiments, the databases 110 reside in a connected server or a cloud computing service. Regardless of location, the databases 110 comprise a memory to store and organize certain data for use by the computing device 108. In one embodiment, the database 110 is configured to store a plurality of users' profile information.

In one embodiment, the computing device 108 comprises at least one processor and a non-transitory memory unit or computer-readable medium or memory unit coupled to the processor. The memory unit stores a set of instructions executable by the processor configured to provide customizable jobs and services, thereby allowing employers to recruit suitable candidate profiles based on assigned task and candidate expertise as well as employees to look for suitable jobs offered by the employer. In one embodiment, the memory unit could be RAM, ROM (including EPROM, EEPROM, PROM).

In one embodiment, the computing device 108 is configured to simulate an employment process by creating a unique platform with maximum possibilities for short-term employment. In one embodiment, the unique platform allows employers and employees to come together to perform or ask for any services/tasks/expertise without a middleman, thereby connecting people from different backgrounds and industries to come together under a single platform and help each other in diverse expertise.

In one embodiment, the platform intends to create a live platform in the online world to enable everyone to give to and get services from any other member of the society. For example, when a user entering into a cafe, a waitress is employed for a couple of seconds to prepare and give the order and the user becomes a temporary employer at that moment mostly without realizing it and when another person asks the user to perform any jobs/tasks, the user becomes an employee. This situation happens on a daily basis. Similarly, to use mobile and computer, the mobile network companies are employed to give internet access for the employment process. Mostly short-term employment is happening constantly in lives without realizing it in many cases. In an exemplary embodiment, the unique platform is trying to simulate the same processes with the use of technology to maximize the possibilities. The platform brings employers and employees together under a single platform to perform or ask for any services/tasks/expertise without a middle-man would eventually result in faster communication, saving cost, and creating opportunities for others who are looking to work extra hours and gain additional income. In one embodiment, the unique platform ultimately connects people from different backgrounds and industries to come together and help each other in diverse walks of life. This would increase profitability and stimulate a sense of usefulness amongst people with different expertise. In one embodiment, the platform aims to provide a valid background of users' working history, their reviews, and quality of their service and expertise.

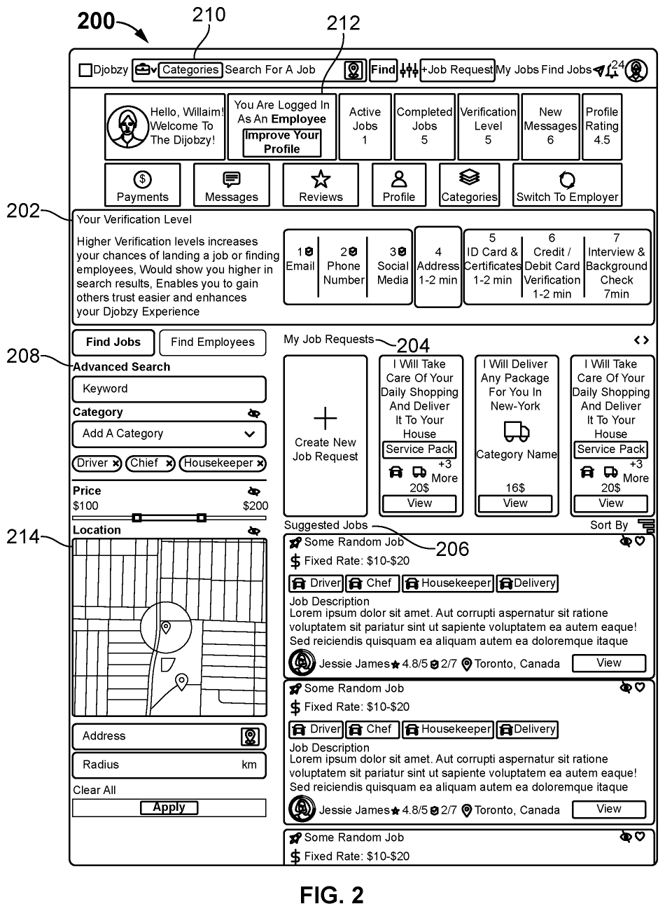

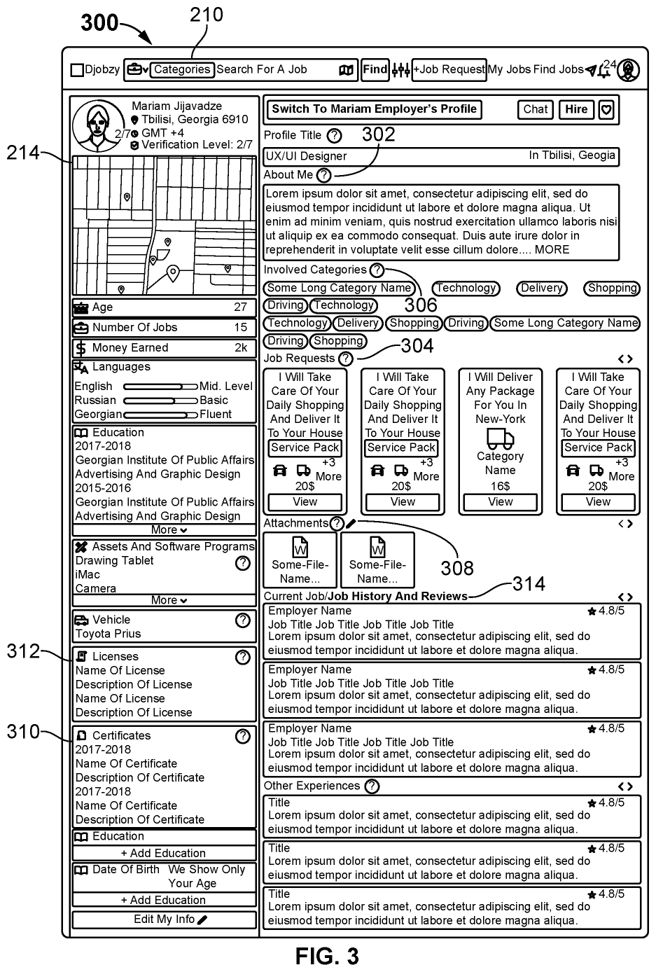

Referring to FIGS. 2-3, screenshots (200 and 300) of an employee's dashboard and an employee's profile respectively, according to one embodiment of the present invention. The screenshot 200 shows the employee's dashboard. The employee's dashboard includes one or more main components such as statistical information about the account, verification levels 202, Promoted Services or Job Requests 204, suggested jobs 206, and advanced search 208. In one embodiment, the platform is configured to allow each user to create a unique user account by registering into the system using one or more user credentials to have the user profile and web-shop of services that the user needs or provides under the user account and have a unique link of the user account. The platform is free to sign up for. When the user signs up they need to verify one or more user credentials such as email, phone number and social media account, thereby allowing the registered user to fully access the website functionalities and interact with other users. After two levels of verification, each user will fully unlock the platform's potentials and will be given 2 profiles, an employee's account 212 and an employer's account. The user can choose which account they want to have as the default account and choose a unique username, the user's unique username will be where it is easy to find the user, for example, user Reza can be found at: https://www.djobzy.com/reza. This feature enables people who want to sell and buy (give and get) services to be able to easily create a username and sell or buy (give and get) services there within minutes, much more effective than making a website for services. Also, this feature enables employers to easily create an account and look for the services they need.

The screenshots (200 and 300) include a search bar 210 for categories, services/Promoted Services, employers/employees, and jobs. The screenshot 200 also includes an advanced search 208 that enables users to define the exact service of employer is looking for, keywords details and look for jobs and services based on user's location and the radius of any location they are looking for on an interactive map 214 and search for services or employees on the map 214.

The screenshot 300 shows one or more employees' profile information. The employee's profile information includes description about the user 302, Promoted Services or Job Requests 304, service categories 306, attachments 308, certificates 310, licenses 312, work history and reviews by employers 314, user's work experience outside the platform, and a plurality of general information about the user. The profile page also includes the option to share the profile on other websites and to create a PDF resume using the information on the profile page. The screenshot 300 further includes different features of the employee's section. In the employee's section, the employees can advertise their services and look for jobs and also write important information about themselves and their services. The employee's section may include a calendar. Within the calendar, they can see the services and times they are booked for and they can use a reminder feature to remind themselves about the job they have upcoming to make sure they won't miss the job. The calendar feature would show others when this user is booked that they can coordinate their errands based on the availability of other users on the platform. Employees can create detailed services that they are willing to provide to advertise their resume and capabilities online for employers from around the world to be able to see them, employees can also create hybrid jobs of their diverse capabilities to respond to the demand of diverse employers who need people who can multitask and have diverse expertise.

In service packs and Promoted Service/Job Request 304, employees can select diverse industries that they have experience in and write about themselves and request the desired hourly and total price for the service so that employers can know more about them and would send them job offers. The employee can get employed instantly or after chatting and negotiating with employers via the platform. Both employee and employer can ensure the safety and security of the system because before the job has started employee and employer will agree on the job details including prices and terms and they can start with the platform's help to ensure the security of the payment for both parties that will be discussed in the process of employment section.

When trying to create a posting for services that the employee can provide, the employee is given with an option that in 2 easy steps they can advertise their services. It is suggested to the employees to go through the service details either over the keyword search or by going through the list manually to look for different categories 306 they can provide services in. Also, it is suggested that employees involve themselves in as many categories as they have expertise in to get suggested the most relevant jobs on the market and have the highest chances of landing a good job.

According to the present invention, there are 3 ways for an employee to be able to land a job, which includes: employers would advertise a job and employees can bid on that job, the 2 parties can get in touch through live chat and the employer can award the job to the employee the employer likes the most; an employee advertises their services from the employee's dashboard and will get suggested the relevant jobs and also can freely apply and bid on any jobs anywhere and if an employer would like employee's services can recruit the employee for the agreed amount of time and price; and employers can look for employees on the search or on the map and send the employees that look appealing to them a job offer based on the jobs they already created and offer the employee a price. An employee can always get back to the employer with a different price offering and they can negotiate on terms and details of the agreement before starting a contract.

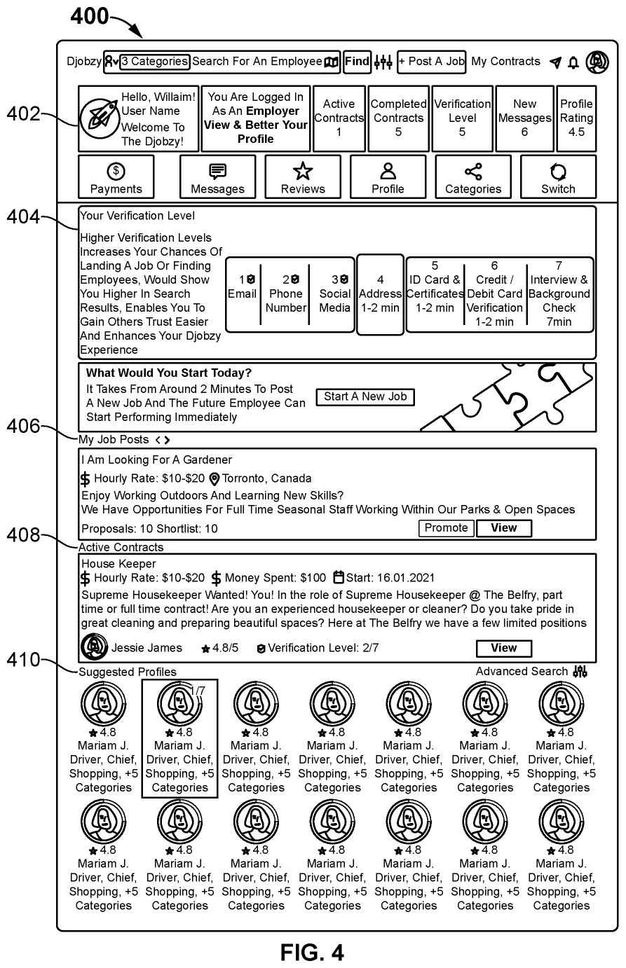

Referring to FIG. 4, a screenshot 400 of an employer's dashboard, according to one embodiment of the present invention. The screenshot 400 shows different features of the employer's section, such as statistical information about the user 402, verification levels 404, job post 406, active contracts 408, and suggested profiles 410. Here the employers can advertise their job posts 406 and look for employees and write important information about themselves. They can have a calendar to track the employees they recruited for diverse jobs to be able to manage their resources, time and budgeting easier. Employers can create detailed job posts 406, advertise them and receive applications from employees from around the world. An employer can create a simple or hybrid job that includes multiple tasks involving different skills from different fields of activity. From here an employer can easily get access to their Wallet, Personal Chat, Reviews page, Profile page, and Search page. Here an employer can track their activities including Active contracts 408, Completed contracts, and some others. It is easy to switch in just one click from your Employer's to your Employee's Dashboard. All the job posts are displayed on this page together with active contracts. From here an employer can go to any of their job posts and take action there. Depending on an employer's activities we provide Suggested Profiles 410, which is the best matched employees list. Instead of posting a job and waiting for applications an employer can also directly send an offer to a particular employee.

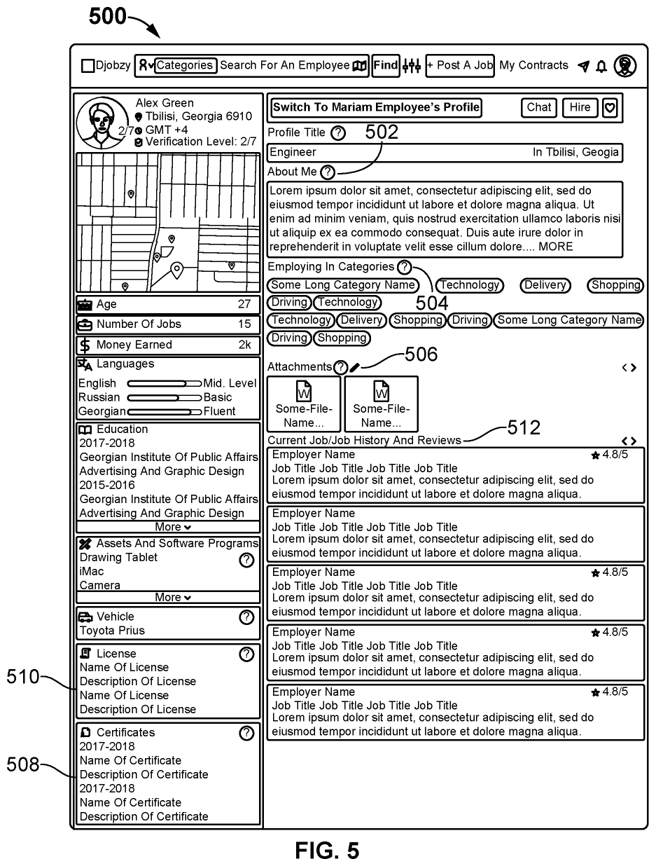

Referring to FIG. 5, a screenshot 500 of an employer's profile, according to one embodiment of the present invention. The employer's profile consists of description about the employer or the company 502, categories that the user is employing in 504, attachments 506, certificates 508, licenses 510, work history and reviews by the employees 512, and a plurality of general information about the user.

The employee profile page 300 and employer profile page 500 are public. Therefore, any potential employee/employer may get to know other users better while exploring on the website in order to make a decision whether to get hired/hire the other party or not. Here an employer gives general information about them, their involved categories, main interests and more data about the other party. In addition, the employer may attach some qualification documents showing their achievements as well as Assets and Abilities in order to build a trustworthy relationship with future employees. In the profiles section, anyone can read reviews from previous employees and see the employer's average rating. Each user has 2 profiles and the users can easily switch between their 2 profiles. Since each user has 2 profiles that give each user 2 separate reviews sections and the user's employer's reviews are being written by the employees who have been in contact with that employer and the employee's average review is being written by the employers who have employed that employee and both reviews are visible publicly. This feature makes the platform even more transparent, which in turn helps people from all over the world to establish productive relationships based on previous users' experiences and create a more trustworthy environment. Further, the employer profile page includes some other general descriptions in the left column such as total number of completed jobs, money spent, employer's skills, the level of education and much more.

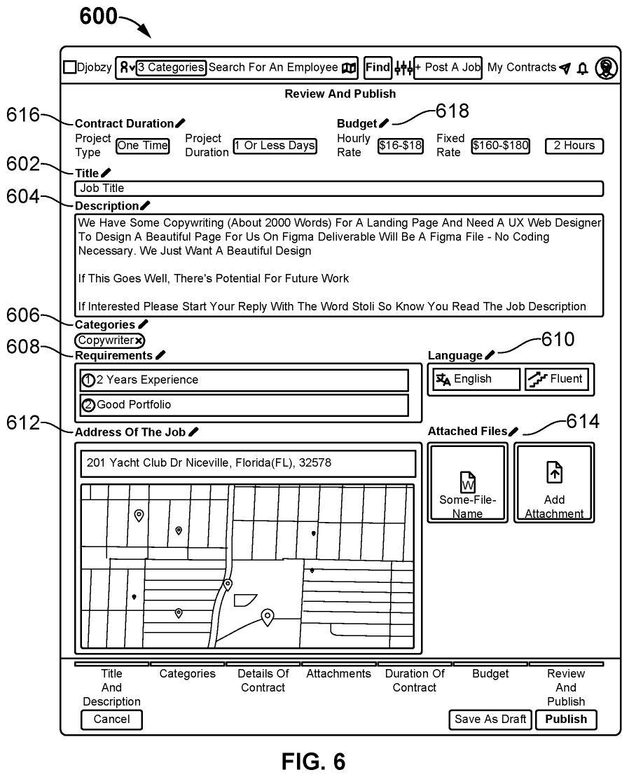

Referring to FIG. 6, a screenshot 600 to create a job post, according to one embodiment of the present invention. In order to create a job post, the employer must provide at least 8 forms of data including, but are not limited to, Job title 602, Job description 604, categories that the job related to 606, job requirements 608, language 610, job location or address of the job 612, attachments 614, contract duration 616, and budget 618.

In one embodiment, the job post is created by the employer using the following steps. At one step, an employer names the job and gives it a general description. At another step, a category or categories should be applied to the job post which helps potential employees to find this job by a category they are interested in. At another step, an employer shares details of the contract: any technical requirements or particular skills can be claimed here together with a required level of language as an option, address of a job or marking the job as Remote, the Employer can also both include the address and mark the job as Remote. At another step, an employer can attach any document or documents related to a job. At another step, an employer selects the duration of the contract. The contract may be a short-term contract, a long-term contract, or a contract with a particular number of days. At another step, a budget setup is applied which includes both hourly and fixed rate. Based on these two parameters the expected total amount of hours is automatically calculated. It is important to note that these parameters can be changed by an employer or an employee as a result of their direct negotiation and mutual consent before starting their contract. At another step, review and publish is applied. Here an employer can change any of his previous selections or typing before publishing a job post.

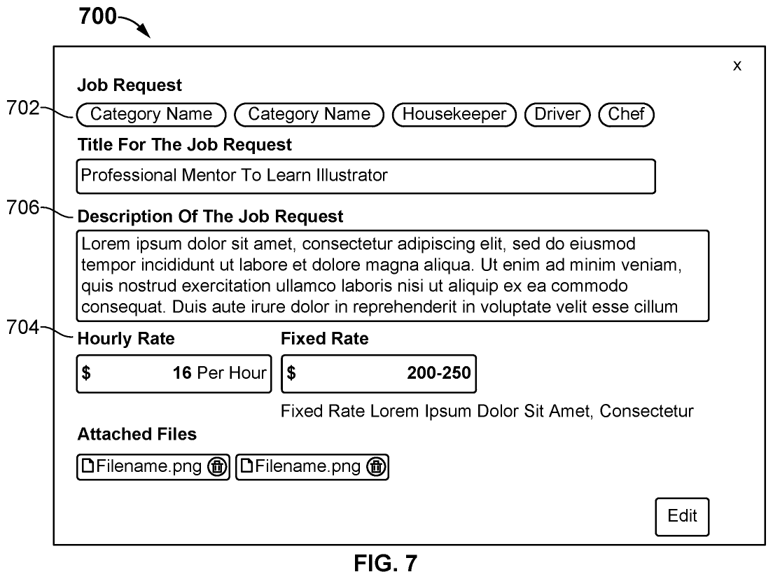

Referring to FIG. 7, a screenshot 700 to make a Promoted Service (Also called Job Request), according to one embodiment of the present invention. The employee creates offered services or Promoted Services they can provide by choosing one or more categories 702 and creates unique services by adding price 704, and description 706.

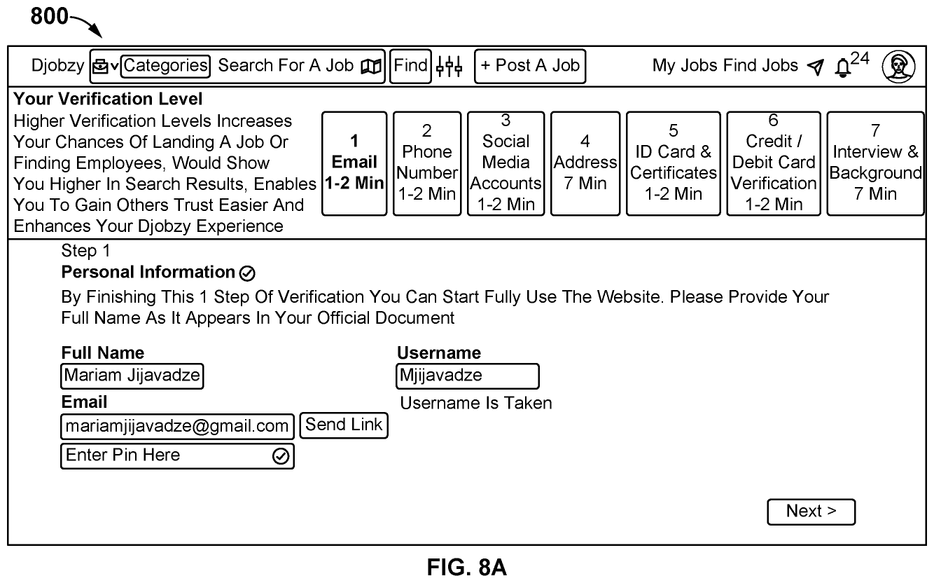

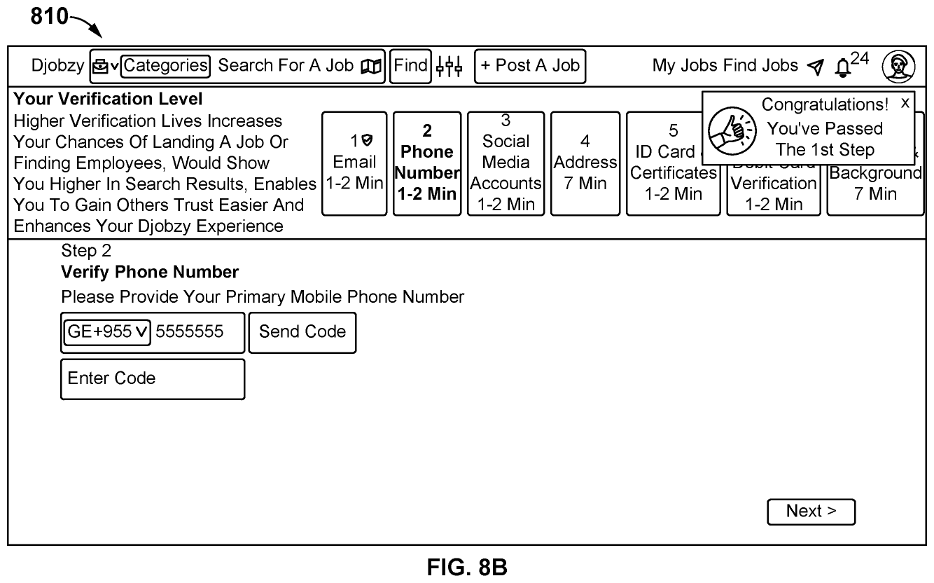

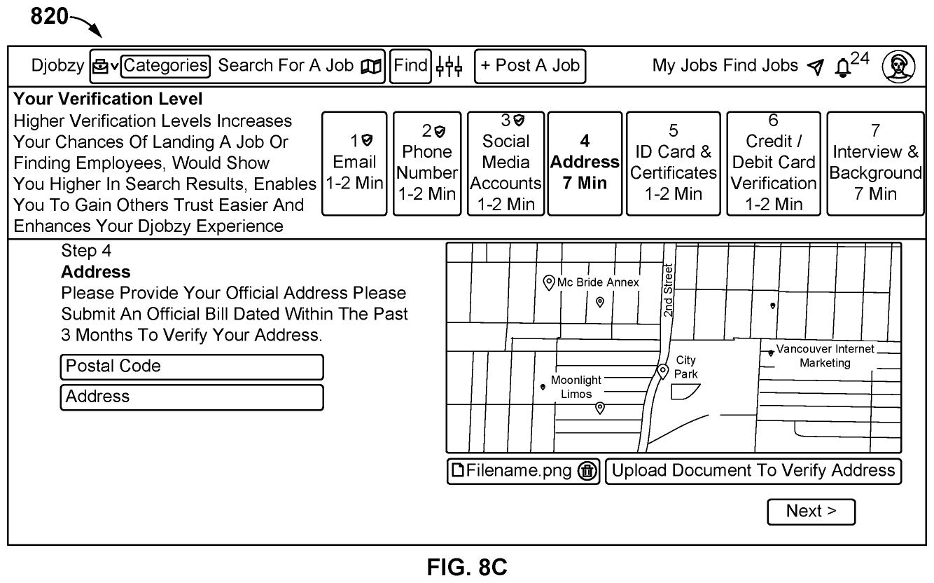

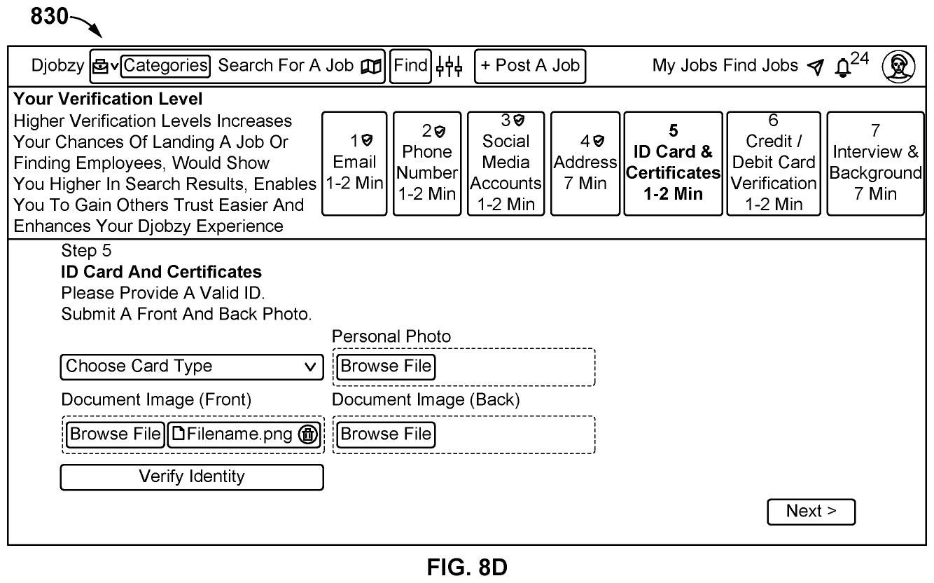

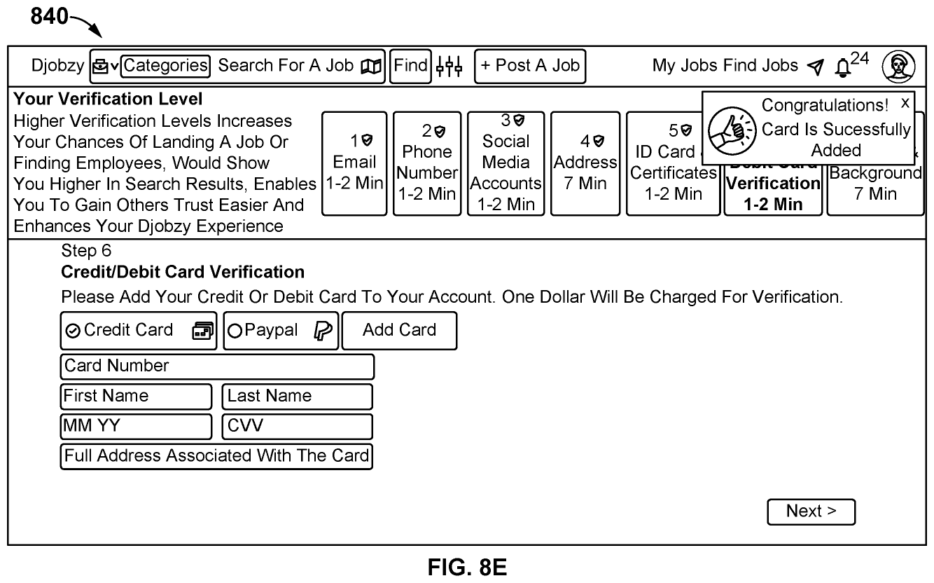

Referring to FIGS. 8A-8E, screenshots (800, 810, 820, 830, and 840) of verification steps to raise a user's verification level, according to one embodiment of the present invention. All users are required to go through a 7-step verification process in order to raise their verification level. To be able to get a standard access to the platform, a user must reach the level 3 of verification. High verification level increases a chance of landing a better job or finding a better employee. The verification steps include email confirmation, phone number, social media accounts, address, ID card & certificates, credit & debit card, and interview & background check.

In one embodiment, the verification system helps to increase the mutual trust between users and it has different levels, users are welcome to verify to as high a level as they desire but it recommends everyone to verify to the highest level to increase the possibility of rather higher level of instant trust for other users and stimulate their recruitment opportunities. The higher the verification level one would have the more job offers/applications that a user can receive from other users.

The 7-step verification process includes the following steps. At the first verification level, personal information such as full name as it appears in official document, username, email ID, and password or pin is verified (as shown in FIG. 8A). At the second verification level, phone number verification is performed (as shown in FIG. 8B). The email verification and phone number verification are obligatory for all users who want to register and be in contact with other users but next levels of verification are totally up to the user's own preference. After a user has their email and phone verified, they can start exploring the website freely and are allowed to use all the site features freely, including hiring/getting hired, and being in direct contact with other users. Optionally, at the third verification level, a user can connect their user account with any of their social media accounts. At the fourth verification level, the users are required to provide their address information by uploading their official address data from a bill or bank account statement dated/issued within the past 3 months (as shown in FIG. 8C). At fifth verification level, it is required to provide a valid ID, Driver's license or passport by submitting its front and back photo or document's scan and submitting a selfie picture, this information will be sent to a trusted and regulated API (ID Analyzer) and gets verified by ID Analyzer (as shown in FIG. 8D). At the sixth verification level, a credit or debit card information is verified by charging 1 US dollar (as shown in FIG. 8E). At the seventh verification level, interviews are conducted for users for about 5-10 minutes asking general questions about their working skills, working approach, experience, and so forth. The users have the option to apply for a police certificate from their city and region. The police certificate is sent for review and if everything looks fine, the system will grant the user at the seventh verification level and they are fully verified at that stage.

In one embodiment, each user account has a settings panel. The settings panel has 8 sections. To get access to the settings panel, a user should enter the account's password. In the first section named Account, a user can change their corresponding email, name, or username, also here the user can choose to close their account. If an account is deleted its username becomes available to any of the users again. Deleted accounts cannot be recovered. On the Profile Settings page, the user may set their employer's & employee's default categories. Also, the user can choose which of their accounts will be primary and default profile upon entering the website and default profile can be changed in the settings. In this section, the user can link some of their social media accounts to their default account. By doing this a user completes the verification level three automatically. In the Contact Info section, a user can set or change their phone number, address, and time zone. The Billing method page contains a user's card information in order to make it easier to send payments each time it is necessary. The user can adjust notifications on the settings panel, to activate or deactivate notifications and turn on/off its sound. In the security section, the users can change their passwords. In the Identity Verification section, one can upload or update their ID and apply for an interview to hopefully get the 7th level of verification. In the Verification Steps page of the settings panel, a user can check their level of verification and move to the following step of the verification.

Further, the platform provides different ways for finding employers/employees. The easiest way is to use the search box in the header. There is also an advanced search column on the Dashboard page. The ability to search on the map is also available. On the job search result page, promoted jobs are listed first and after that jobs in order of relevance are listed. On the employees' search result page, promoted profiles with promoted services or service packs are listed first and after that the profiles in order of relevance are listed. There are many filters on the Advanced Search panel which are used to narrow down the results to the user's desire. The filters include, but not limited to, keyword, category, verification level, bid amounts, price, and location. Further, the sorting options include, but not limited to, date added, price, and distance. All the main details regarding job posts/employees are provided in the feed.

In one embodiment, an employee can promote their service/services in either one category or a set of categories just like an employer can promote their job. In both cases, the promoted posts will get higher visibility and would show higher related results. Promoted services will be shown above others.

In one embodiment, the system further comprises a chat feature. The chat feature helps the 2 parties to be able to interact more easily, negotiate, brainstorm and find a feasible way to help each other and tackle problems. They can come to an agreement that is good for both parties and they can talk about the contract terms in detail and the job they are willing to start. The chat feature also enables parties to exchange files and keep track of the working process. If there are any new unread messages, the system notifies a user either through the website notifications mechanism or via email. The chat includes notifications as well. When a user is hired, receives an application, receives an offer and/or other similar actions occur, the user will receive a chat notification with details of that action.

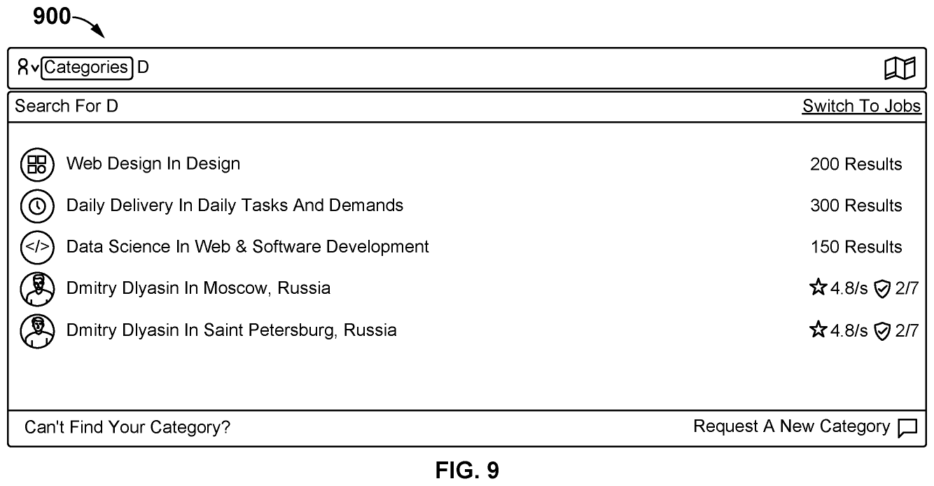

Referring to FIG. 9, a screenshot 900 of a search system, according to one embodiment of the present invention. The search system enables users to search for any listed categories of services, job posts and employee profiles. The main search provides the possibility to search for categories as well as employees or jobs. The design of the search system shows the important information that is needed to take an action. The search engine takes into account the preferences of the logged in user to bring the most relevant results for them.

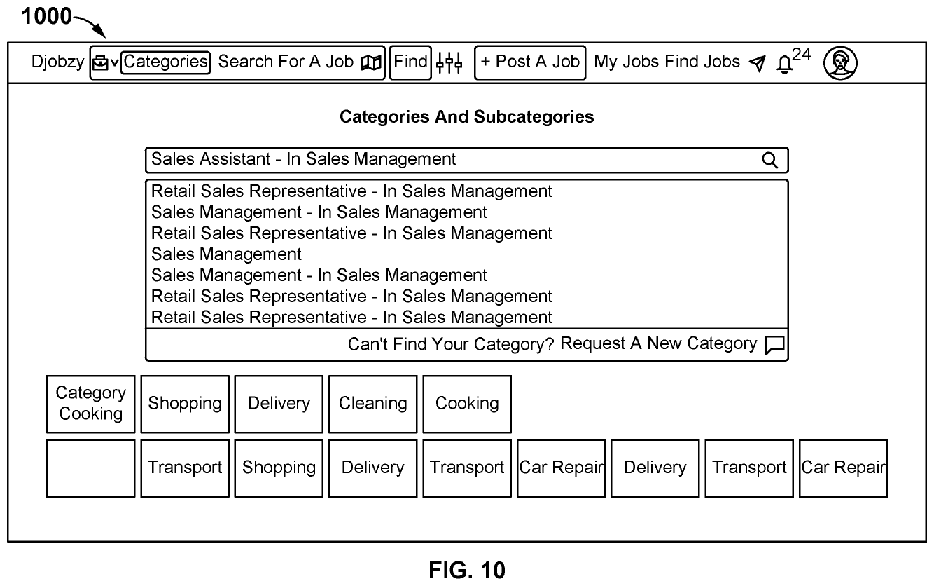

Referring to FIG. 10, a screenshot 1000 of a category browser, according to one embodiment of the present invention. The users are provided with a large list of carefully curated categories to select a particular category when searching for jobs or employers, services and employee profiles. The categories are split into 3 abstractions such as category, subcategory, and sub subcategory. The categories section tries to use diverse algorithms to connect people with the most relevant industry and type of job, service, or errand they may be interested in. The system utilizes one or more dedicated algorithms and AI to gather as much information as they can to get smarter and better in time and provide better user experience, currently, it covers the categories of about 1500 fields and sub-categories of about 60 main industries. The system helps to create every job post under one or multiple categories. That helps potential employees to find and locate it more easily. On the other side, each employee is involved in 1 or more categories and that way more categories and people are correlated and connected together.

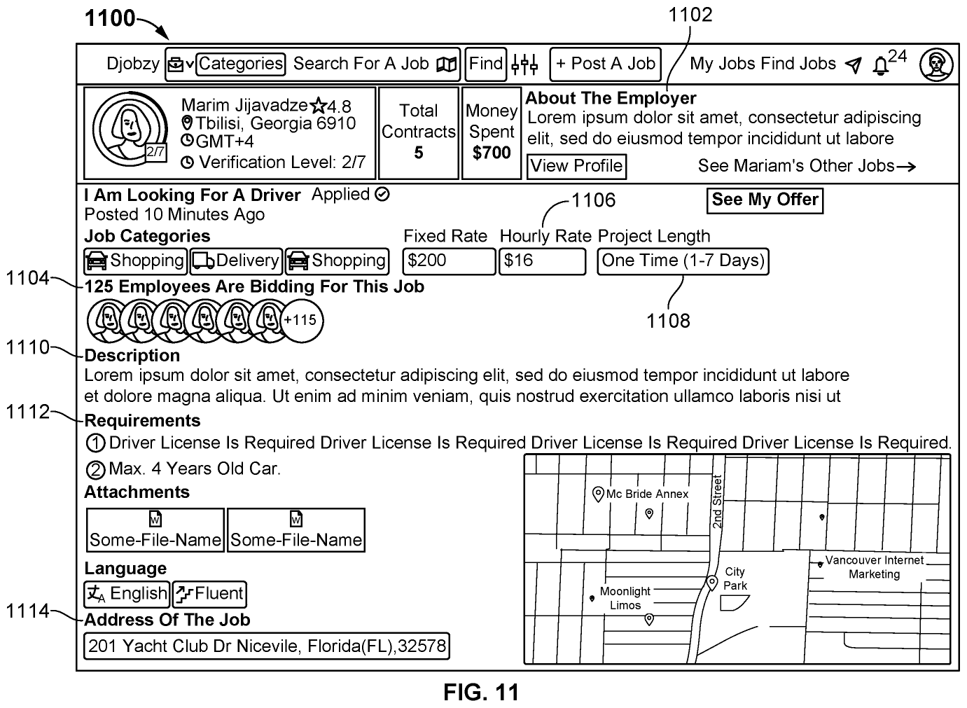

Referring to FIG. 11, a screenshot 1100 of a job post, according to one embodiment of the present invention. The system allows the users to view the details of the posted job and all information provided by the employer to apply for the position. Each job post has many parameters to go through in order to make a decision whether to apply for it or not. The parameters may include some relevant information about the employer 1102, number of bids for job posts 1104, price 1106, project length 1108, detailed description 1110, requirements 1112, address 1114, and some more. If a job post contains something inappropriate, there is an option for an employee to report it. If an employee would like to propose an offer or a bid on a job, the employee candidate can easily apply for the job. The system also allows the employee candidate to change their bid at any time until the job is available. The person who posted a job can change its price only before anyone applied for it.

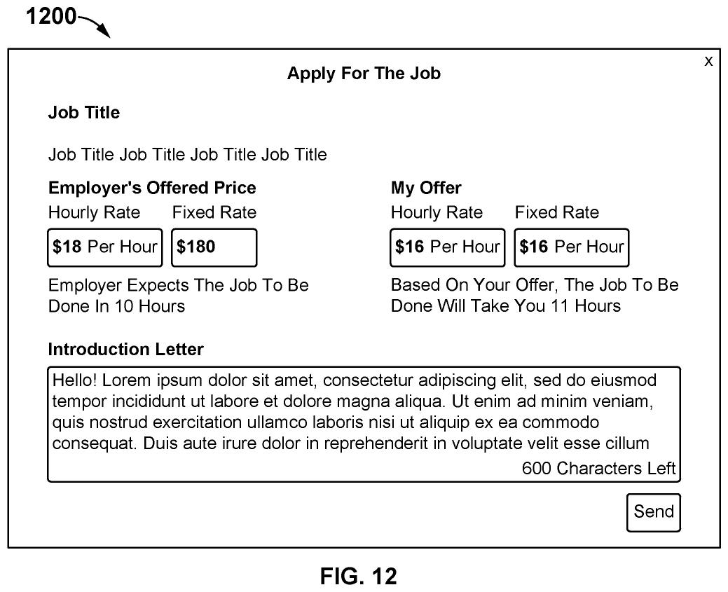

Referring to FIG. 12, a screenshot 1200 to apply for the job by an employee candidate, according to one embodiment of the present invention. When the job is published anyone can see it and apply for it if the requirements and conditions are appropriate for the applicant. The user needs to type a request in a search section specifying which type of a task they are looking for in order to find a job. On the Search Result page, the user may select any job and apply for it. The employer can post a job and therefore will receive different proposals with proposed bids that can be smaller or bigger than the price in the job post. The employer then will see all the proposals and will be able to choose any individual/companies and start a conversation with them through the chat feature or other communication methods on the platform. Therefore, the parties can negotiate the job and service details and will agree on a price to start a contract.

The employer provides an hourly rate and a fixed rate price parameter while creating a job. The hourly rate and fixed rate are used to calculate total time investment from potential employees. Based on this data, the number of approximate hours needed to perform that job will get calculated and appear automatically. An employee can introduce themselves, describe their competencies, and send their application to an employer. Similarly, the employees/candidates are allowed to create a counter offer if they are not happy with the budget plan provided by the potential employer. The employee candidate has to provide an introduction letter to explain how they fit to the job and why the potential employer has to hire them, and describe their work experience.

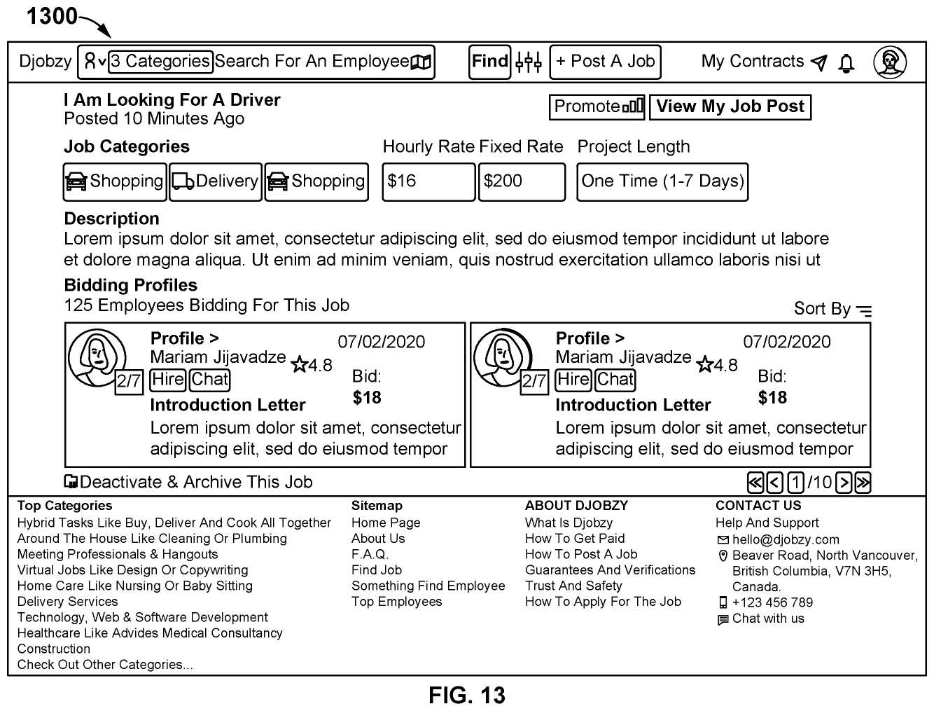

Referring to FIG. 13, a screenshot 1300 of bidding profiles, according to one embodiment of the present invention. The employers may view all the received bids to pick up the best one. Also, the employer may start a chat directly to an employee whose bid is appealing to the employer. It is easy to hire the employee candidate using a couple of clicks. Employees may see other users' bidding amounts and use the information to decide their own bid amount.

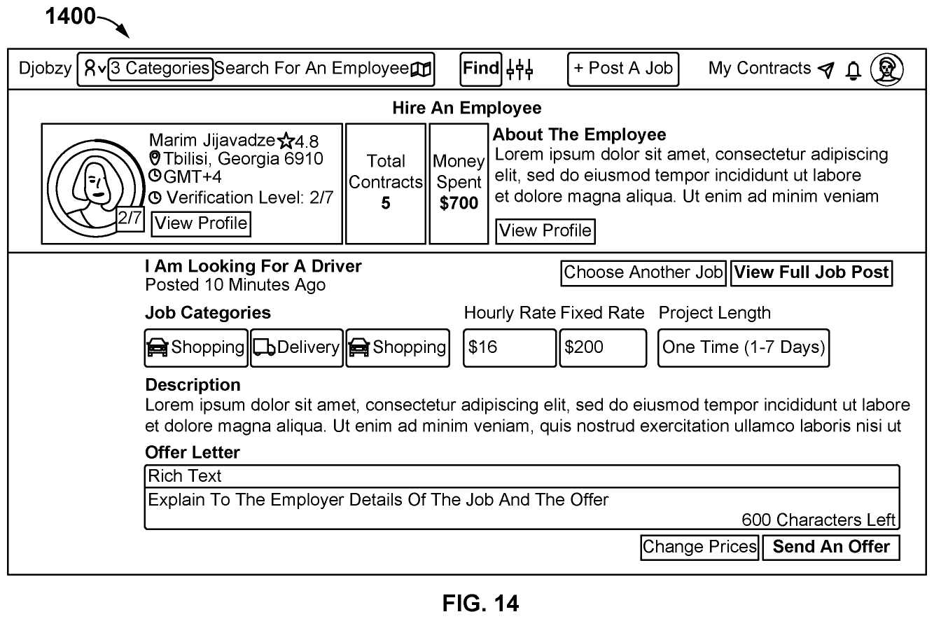

Referring to FIG. 14, a screenshot 1400 of a job offer sent by an employer, according to one embodiment of the present invention. The employer browses and hires available candidates on the platform. The employer may directly offer a contract to any potential employee on the platform. In order to do so, the employer needs to get to the potential employee's profile page and click on the “Hire” button. In the dialog box, they should pick up an active job that they want to offer to that particular potential employee, write an offer letter, set hourly and fixed rate offers, and the employer can easily hire the required candidate. Therefore, the employer also sends an offer letter to the potential employee even if the employee has not applied to the job.

During an active contract, an employee can request to change the payment for the job. The system provides a dedicated user interface accessible to employees within the job payment page. To initiate a payment change, the employee selects the option “Request to Change My Current Offer.” This action triggers a dialog box for entering the reason for the request and specifying the desired payment amount. Upon receiving the employee's payment adjustment request, the employer is notified and presented with the option to either accept or decline the proposed changes. The employer's decision directly impacts the final payment terms for the active contract.

When the job is ended, the employee is asked to leave a review to the employer in order to release the payment from the Escrow account. The employer is also required to leave a review to be able to end the job successfully, thereby providing guarantee and helping in building the reputation of the users and creating a safe and real atmosphere with valid reviews that can give a fair judgment for the future transactions of users in the platform. The reviewing section consists of one or more attributes such as skills, value, manner, timeliness, and result. Each of these attributes is rated on a 1-to-5-star scale. Testimonials also have to be provided by the users.

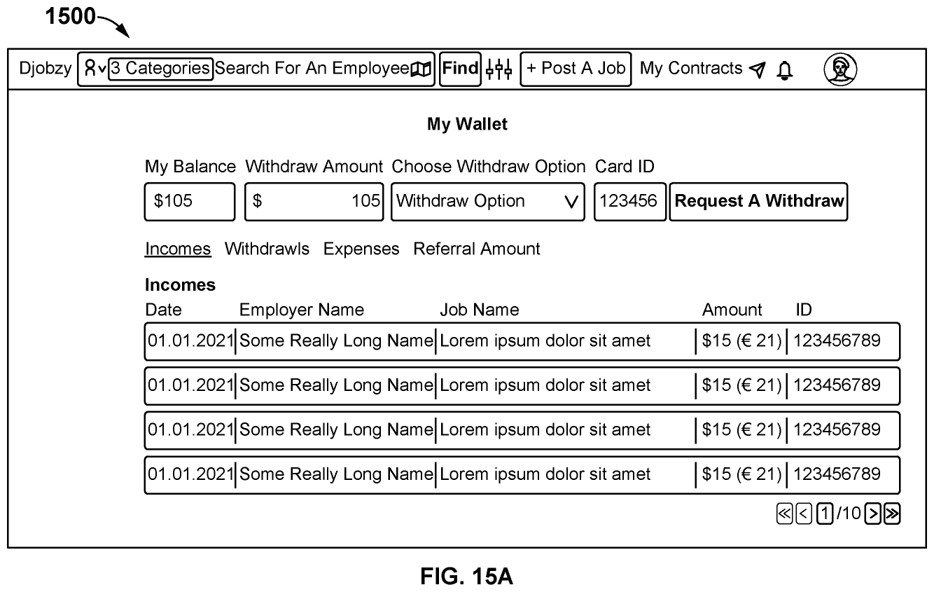

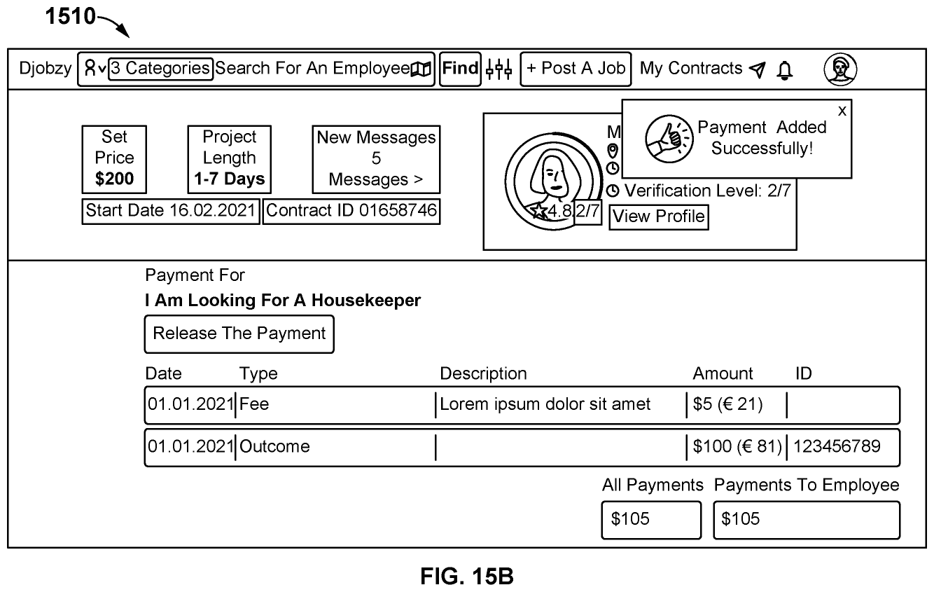

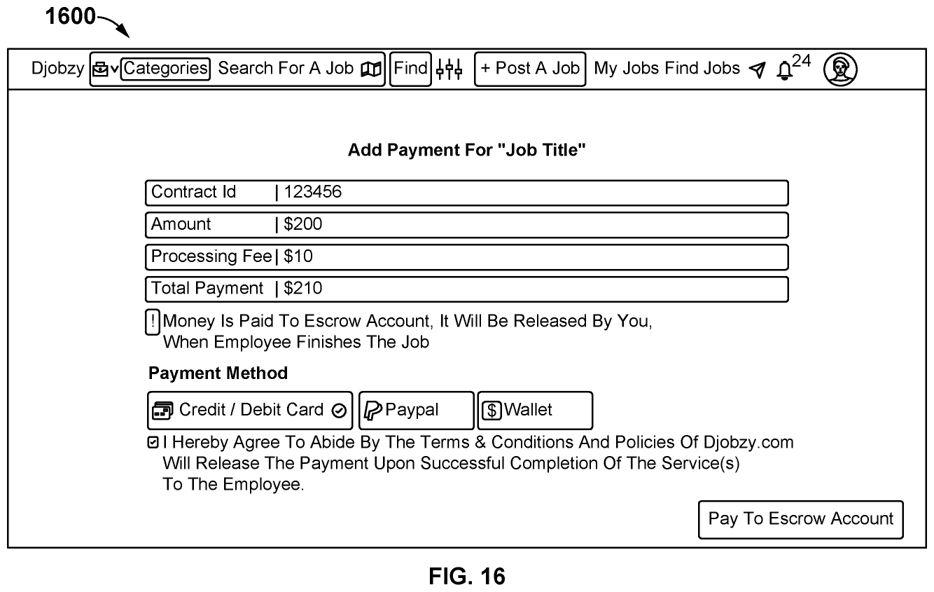

Referring to FIGS. 15A-15B and 16, screenshots (1500-1510 and 1600) illustrating wallet and payment methods, according to one embodiment of the present invention. The users have access to their wallet at any time and can request a withdrawal of any available amount. In the wallet section, a user can see all pending or completed withdrawals or payments, and can track all the transactions related to them. The user may withdraw money to a bank account, credit or debit card, or PayPal account (as shown in FIG. 16). To pay for a job, the employer can also use a credit/debit card or PayPal account. All the payments on the platform are secured and protected through the Escrow account.

In one embodiment, the Escrow wallet secures the deal and protects both parties from malicious acts. The escrow is a transitional account that helps both the employer and employee to protect their interests. When an employer hires someone, they get advance and this money goes to an escrow account. If the employer confirms that the work is done successfully, the platform releases the money to the employee. If anything goes wrong, the platform mediates to make sure that the interests of both sides are met. In one embodiment, a user can dispute a contract if she/he has a complaint about the other side. Djobzy customer service will review the complaint and act accordingly.

Further, users' earnings on the platform are their own personal income and taxable according to the jurisdiction that the employee or company is working in and based on the local, provincial authorities. Users are responsible to pay their own due taxes based on their own taxing jurisdiction and on their own responsibility.

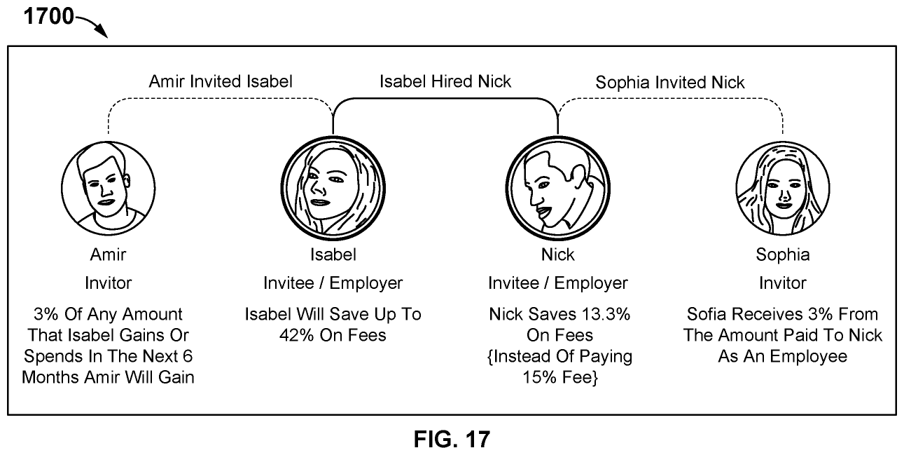

Referring to FIGS. 17, a screenshot 1700 of a referral system, according to one embodiment of the present invention. Although most companies pay a fixed amount to users to refer others, Djobzy platform offers different types of discounts and passive income. The users can earn unlimited passive income through a unique referral system. The platform provides a win-win scenario for all parties. An Inviter receives passive income of any amount that an Invitee gains or spends in the next 6 months after introduction and an Invitee saves a percentage on the platform fees when hiring or being hired by someone.

In addition, one of the determinative aspects of the service is the ability of a user to create and apply for hybrid tasks. For example, a person needs someone to go to a grocery shop, buy fruits and vegetables and deliver these purchases to their house, cook dinner, then deliver books to a friend of theirs, and bring a couple of books to another location. There are five tasks within this job. There can be 10 tasks or multiple tasks in multiple days and there is literally no limitation. A job can have as many tasks on a single or recurring basis as needed. To perform the task, the employees and employers are connected through the connection channels such as Chat, App, based on the job and services they want to give or accept and chat in details about those jobs to agree on payment amount and details.

In one embodiment, the platform provides a mentoring service. People from diverse backgrounds and expertise can provide the mentoring service. Mentoring/Meet a TOP Professional in the platform expands the user's contacts list and creates opportunities and gives birth to ideas and increases workflow. Meet other smart individuals or companies in their own industry or any industry of desire. Usually, people use acquaintances if they have any or read books or watch interviews, but all these channels of communication don't allow the user to ask as many questions as the user might need and to receive instant answers, plus ask additional questions. The user can easily find professionals from different walks of life to learn from or the user can be a professional who likes to teach others something.

In one embodiment, the user profile on the platform, reviews, and work history can become the proven resume of the user's expertise. Anyone can publicly search and see the user's portfolio and true capabilities and interact with the user based on their experience, expertise and employ the user or get employed by the user. When the user moves from one location to another, they won't have contacts and acquaintances. By changing the profile location on the platform, the user can simply bring all their experience along with their reviews to the new location. Further, people looking for the services can easily find the user in the new location and interact with them. The user profile on the platform always moves with the user and works as the user's Career Passport and a great asset. Also, the profile is a live reference showing all the past jobs and good capabilities that make the user stand out from the competition. The platform allows more qualified people to show their capabilities based on their previous real interactions, reviews and prove how effective their services are.

Advantageously, the platform allows the user to change the process of employment for companies and entities. Current Process of employment is an outdated and time-consuming process with more complexities in finding the perfect matches for the job. Using the current customizable platform of the present invention, an employer can simply post the job, qualified people (potential employee candidates) with live reviews from their previous job experiences would apply for the job, the employer gets the chance to see potential employees based on what they have already accomplished and their reviews and verification levels and can read in more details about those potential employees before committing to even an interview. The unique platform eliminates the time required for posting a job and reviewing and interviewing lots of people and filtering and organizing tests. The system of the present invention allows the employer to see the employees profile in details including the certifications, assets, earned income, reviews, qualifications, pictures and details of the employee and offer them the job for a couple of hours without any long-term commitment to the employee and pay the funds in escrow account. The system does not require any other contract and lengthy legal documents and the employer can see the employee in action for a couple of hours and judge the employee based on their performance after a couple of hours and days without any extra commitment. On the other hand, an employee doesn't need to go for several long interviews and incur all the costs and losing time and resources hoping to get a job. The unique platform creates a fair environment for both parties to be able to check each other's capabilities and desires before entering into any longer-term commitments of employment through the platform.

Furthermore, the platform makes the employment process not only way faster but also much cheaper for companies and employers. Employees can work as self-employed and are responsible for their own insurance and social benefits; Also, Employers don't need to commit to certain benefits including social insurance, retirement, paid holidays, while the platform is trying to cut the cost of employment it also takes lots of responsibilities away from employer's shoulders by giving the option of self-employment based on the agreed price on the employee's side. The employee can charge the employer directly for the charges that they feel comfortable with. At any given time, there are people with free time and desire to provide a service, using their time/talent/expertise and get compensated for their service. No matter what the user's employment status is, through the platform anyone can earn additional income, users can be companies, fully-employed individuals, self-employed, students, part-time employed, retired, and willing to take on more tasks to get additional income around their schedule.

On the platform, an employer can buy insurance to cover a failure of contract obligations from an employee's side as well as an employee can buy insurance to cover a failure of contract obligations from an employer's side. For those users who don't even have an internet connection Djobzy is going to provide a local office service where anyone can require a service or provide a service through the platform. Djobzy ambassadors can bring diverse resources & find opportunities in different cities and countries globally to help solve problems and bring greater awareness and increase revenue. Djobzy is a platform which is going to widely use artificial intelligence and robotics to make such things like advanced search, suggestions, customer service more efficient and precise and therefore to help solve daily hassles for our users.

Djobzy offers a blog page to increase user engagement and information dissemination. This blog page serves as an augmented communication channel, offering users insightful content that elucidates website operations, while concurrently delivering the latest news, innovations, and trends pertinent to the industries in which users seek employment or provide services. The blog page is designed to deliver informative content that aids users in comprehending the intricacies of the platform. This includes detailed explanations of features, step-by-step guides, and illustrative materials to enhance user understanding. Users receive real-time updates on the latest news, inventions, and advancements within the industries relevant to their employment pursuits. This feature ensures that users are well-informed about current trends and emerging opportunities within their chosen sectors.

Djobzy offers a method to improve user interaction through an AI-based chatbot on the website. The feature enables users to engage in interactive conversations with an AI-based chatbot designed to enhance their understanding of the website's features. The chatbot employs natural language processing and machine learning algorithms to provide informative responses, guidance, and support to users navigating the website. The chatbot dynamically delivers relevant information and assistance based on user inputs, adapting its responses to cater to the specific needs and inquiries of each user. This ensures a personalized and responsive interaction. Users can inquire about specific features or functionalities of the website, and the chatbot is programmed to provide informative demonstrations and explanations, aiding users in exploring and comprehending the website's capabilities.

Preferred embodiments of this invention are described herein, including the best mode known to the inventors for carrying out the invention. It should be understood that the illustrated embodiments are exemplary only and should not be taken as limiting the scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated here.

What claimed is:

1. A computer-implemented system for providing customizable jobs and services platform, comprising:
a computing device having at least one processor and a non-transitory memory unit coupled to at least one processor, wherein the non-transitory memory unit stores a set of instructions executable by the processor configured to provide customizable jobs and services platform, wherein the system is in communication with the computing device via a communication network;
one or more databases in communication with the computing device via the communication network configured to store a plurality of user profile information, and
a user device associated with each user in communication with the computing device via the communication network configured to access one or more services provided by the system, wherein the computing device is configured to,
simulate an employment process by creating a unique platform with maximum possibilities for short-term employment,
wherein the unique platform allows employers and employees to come together to perform or ask for any services/tasks/expertise without a middle-man, thereby connecting people from different backgrounds and industries to come together under a single platform and help each other in diverse expertise.

2. The system of claim 1, wherein the user device is configured to communicate with the computing device via the communication network using an application software or mobile application or web-based application, or desktop application executed in a computer-implemented environment or network environment.

3. The system of claim 1, wherein the short-term customizable job service is configured to enable the user to find the right candidate to get work done and at the same time to find a job to work on to make extra income.

4. The system of claim 1, provides possibilities for users to employ and get employed on their own schedule in their own industry with the most competitive prices without any middle-man.

5. The system of claim 1, wherein the platform is configured to allow each user to create a unique user account by registering into the system using one or more user credentials to have the user profile and web-shop of services that the user need or provide under the user account and have a unique link of the user account.

6. The system of claim 1, wherein the unique platform allows the user to register into the system using one or more user credentials to get access to multiple user accounts including employer's account and employee's account configured to provide and receive any services immediately.

7. The system of claim 6, wherein the user selects any one of the user accounts to have as a default account with a unique username and a profile link.

8. The system of claim 1, locates employees, service seekers, and employers on an interactive live map.

9. The system of claim 1, further comprises a plurality of categories for jobs and employers on the interactive map with the location of job sites and the employees.

10. The system of claim 1, wherein the employer creates a job post with title and description, categories, requirements, language and job location, attachments, contract duration, and budget.

11. The system of claim 1, wherein the employee creates a Promoted Service/Job Request by choosing one or more categories and creating unique services by adding price and description.

12. The system of claim 1, further comprises multi-level verification steps configured to raise their verification level, thereby increasing the safety, stimulating mutual trust between users while keeping the flexibility for users to opt the level of verification they want to be in, and therefore higher level of verification can lead to higher chance of landing a good job or finding the proper employee/tasker.

13. The system of claim 1, further comprises a search system configured to provide a possibility to search for categories as well as employees or jobs.

14. The system of claim 1, further comprises a wallet and payment system configured to track pending and completed transactions, balance, and view all funds that are ready to be released once both the employer and employee have deemed the job completed.

15. The system of claim 1, further comprises an escrow account configured to protect both employers and employees from malicious acts, takes blind trust out of the equation, and guarantees satisfaction on both sides before the transaction is completed.

16. The system of claim 1, allows the users to hire an employee for any hybrid job that requires diverse expertise, choose diverse industries, and find a personal assistant.

17. The system of claim 1, further allows the employee to advertise their services on the unique platform that are noticeable by many employers requiring such services.

18. The system of claim 1, is configured to shop for services for the best price, create a web-shop of services in a couple of minutes, and sell the services to get paid instantly.

19. The system of claim 1, enables users to come together and perform activities of diverse sorts, suggesting and creating new categories and industries in different parts of the world, activities and industries are only limited by the laws of the jurisdiction they are being advertised in and could entail any category or industry or job and tasks even including any sports, social gatherings, events to any other demand or supply and other activities and further enables an employer to hire a person in another country for short-term virtual remote and non-virtual physical job.

20. The system of claim 1, enables users when moving to a new location to change their profile location to the new address and look for new opportunities, tasks to do, taskers or clients and they can leverage their existing profile and the existing reviews and experience to work in their advantage as a reference and be able to work in their own industry rather than starting from ground 0, thereby helping people save years of their life and instantly bring the existing user in new location relevant clients and requests leveraging their existing Djobzy profiles, thereby building a great profile and gathering good reviews could be key to building a strong reference that could be used and trusted globally.
